(19) United States
(12) Patent Application Publication
(10) Pub. No.: US 2017/0195776 A1
(43) Pub. Date: Jul. 6, 2017

(54) Earphone with noise reduction having a modified port

(71) Applicant: GN Audio A/S, Ballerup (DK)

(72) Inventor: Jacob REIMERT, Ballerup (DK)

(21) Appl. No.: 15/384,424

(22) Filed: Dec. 20, 2016

(30) Foreign Application Priority Data
Dec. 30, 2015 (EP) 15203194.4

(51) Int. Cl. H04R 1/10; H04R 1/28; G10K 11/178

(52) U.S. Cl. CPC H04R 1/1083; G10K 11/1782; H04R 1/2826; H04R 1/1008; G10K 2210/1081; G10K 2210/3026; G10K 2210/3027

(57) ABSTRACT

An earphone is provided, the earphone being configured to provide an acoustic output signal to an ear of a wearer in dependence on an earphone audio signal and further configured to be arranged on the wearer's head in an operating position such that a front cavity between the head and the earphone is separated from ambient space. The earphone comprises a housing having a housing wall separating a rear cavity from the front cavity and from ambient space, an ear cushion, a first diaphragm suspended across an opening in the housing wall between the front cavity and the rear cavity and configured to be actively driven. The earphone further has a port structure fluidly connecting the rear cavity and ambient space through the housing wall. The port structure having a first open end fluidly coupled to the rear cavity and a second open end fluidly coupled to ambient space, and having a port cavity defined by the first open end, the second open end and a port wall, the port wall extending from the housing wall into the rear cavity and/or into the ambient space. The port wall has one or more acoustically permeable sections fluidly connecting the port cavity with the rear cavity and/or the ambient space through the port wall.

### TECHNICAL FIELD

The present invention relates to an earphone with noise reduction, i.e. an earphone adapted to attenuate acoustic noise approaching a wearer's ear. The earphone may particularly be implemented in headsets, headphones, hearing protectors and other hearing devices.

### BACKGROUND

In the art, various earphones are known, which employ passive noise reduction (PNR) to reduce the amount of acoustic noise reaching the wearer's ears. PNR is typically achieved by acoustic dampening in structural components, such as earphone shells and ear cushions. It is further known to combine PNR with active noise cancelling (ANC) that actively counteracts acoustic noise approaching the wearer's ears, thereby attempting to cancel out and thus remove the noise from the sound reaching the ears. ANC is typically achieved by controlling the output of a driver in the earphone such that it counteracts the residual noise that escapes the PNR.

PNR is generally effective at frequencies above about 1 kHz, while the effect decreases towards lower frequencies and is practically non-existing at frequencies below about 100 Hz. Conversely, ANC is generally effective in the frequency range below about 1 kHz, while it is difficult to achieve good results for higher frequencies. Noise reduction using a combination of PNR and ANC can thus in principle be made effective within the entire audio frequency range.

For some earphones passive attenuation of ambient noise is desired while at the same time obtaining a proper low frequency audio reproduction.

Typically, earphones providing passive noise reduction and audio are two-chamber earphones, having a front cavity and a rear cavity, and comprising a speaker, i.e. an actively driven diaphragm suspended in a wall between the two cavities.

To obtain a good reproduction of low frequency audio, flow restrictions on the side of the diaphragm facing away from the ear should be avoided or limited. This may for example be obtained by having a rear cavity which is sufficiently large or by having an opening in rear cavity.

On the other hand, to provide good passive noise attenuation the rear cavity should be closed and relatively small which however restricts flow on the side of the diaphragm facing away from the ear.

There is thus a trade-off between passive noise attenuation and good audio reproduction at low frequencies.

It has been suggested to solve this trade-off by providing a so-called vent in the rear cavity, i.e. a hole in the rear cavity covered with an acoustic resistive material. By providing a low vent resistance, a fair low frequency reproduction may be obtained, while a high vent resistance provides for a higher passive attenuation, but a poorer low frequency reproduction.

U.S. Pat. No. 6,831,984 B2 discloses a solution to this problem in a headset. The headset includes an earcup enclosing a front cavity and a back cavity separated by a divider. A driver with a diaphragm is mounted in the divider between the front and back cavity. The headset further includes a circumaural sealing pad constructed and arranged to effectively seal the front cavity to the head of a person. In the back cavity, a port and a resistive opening is provided in parallel to intercouple the interior and exterior of the enclosure through a wall of the back cavity. The acoustic mass of the port and the compliance of the back cavity are tuned to a resonance frequency of about 300 Hz. This causes the back cavity to behave closed above 300 Hz and open below this frequency.

In e.g. U.S. Pat. No. 7,916,888 a further solution is suggested in which an earphone similar to the one described above has a port in the form of a tube in the rear cavity of the earphone which acts as a low pass filter between the sound in the back chamber and the surroundings.

However, such a tube resonates and provides for artefacts at transitional frequencies, e.g. at frequencies between approximately 50 Hz and 1000 Hz.

### SUMMARY

There is a need for an improved earphone, particularly an earphone having good passive noise attenuation while at the same time allowing for good audio reproduction at low frequencies.

It is an object of the present invention to provide an earphone meeting at least some of the needs as set out above.

According to a first aspect of the present invention, an earphone is provided, the earphone being configured to provide an acoustic output signal to an ear of a wearer in dependence on an earphone audio signal and further configured to be arranged on the wearer's head in an operating position such that a front cavity between the head and the earphone is separated from ambient space. The earphone comprises a housing having a housing wall separating a rear cavity from the front cavity and from ambient space, an ear cushion arranged and configured to attenuate acoustic signals entering the front cavity from ambient space when the earphone is in the operating position, a first diaphragm suspended across an opening in the housing wall between the front cavity and the rear cavity and configured to be actively driven to provide at least a portion of the acoustic output signal. The earphone may further comprise a port structure fluidly connecting the rear cavity and ambient space through the housing wall. The port structure has a first open end fluidly coupled to the rear cavity and a second open end fluidly coupled to ambient space, and the port structure has a port cavity defined by the first open end, the second open end and a port wall. The port wall extends from the housing wall into the rear cavity and/or into the ambient space. The port wall has one or more acoustically permeable sections fluidly connecting the port cavity with the rear cavity and/or the ambient space.

According to another aspect of the present invention, an earphone configured to provide an acoustic output signal to a wearer is provided, the earphone having an output transducer, such as a speaker. The earphone comprises passive noise cancelling features, such as an ear cushion configured to dampen ambient audio. The earphone has a housing wall separating a rear cavity of the earphone from ambient space and may have a port structure fluidly connecting the rear cavity and ambient space through the housing wall. The port structure has a first open end fluidly coupled to the rear cavity and a second open end fluidly coupled to ambient space. The port structure has a port cavity defined by the first open end, the second open end and a port wall. The port wall extends from the housing wall into the cavity and/or into the ambient space and the port wall has one or more acoustically permeable sections fluidly connecting the port cavity with the rear cavity and/or the ambient space.

It is an advantage of the earphone according to the present invention that the port structure may act as a low pass filter between the rear cavity (or back chamber) and the ambient space.

It is a further advantage of the present invention that the acoustically permeable sections of the port wall may dampen a resonance of the port structure and thereby smoothen and/or reduce artefacts created at or near the resonance frequency of the port structure.

The earphone may be any earphone, and may e.g. be configured to be worn over the ear (circumaurally), i.e. such that it covers the pinna completely, on the ear (supraaurally), i.e. such that it covers a portion of the pinna, or in the ear, i.e. such that a portion of the earphone protrudes towards or into the ear canal or the earphone may be configured in other known ways, including combinations of and compromises between two or more of the above mentioned configurations.

The earphone comprises a housing having a housing wall separating a rear cavity from the front cavity and from ambient space, and a first diaphragm is suspended across an opening in the housing wall between the front cavity and the rear cavity. The first diaphragm may be reciprocally suspended across the opening in the housing wall between the front cavity and the rear cavity, and may thus be suspended to reciprocate. The diaphragm is configured to be actively driven to provide at least a portion of the acoustic output signal. The earphone may comprise a driver, such as an electrodynamic driver, for driving the diaphragm.

The rear cavity, and the front cavity, may have an acoustic compliance.

The diaphragm, the rear cavity, i.e. the air or the gas within the rear cavity, and the port structure together defines a first acoustic system having a first system frequency response. The first system frequency response may be determined mainly by the acoustic impedance or mass of the diaphragm, the combined acoustic compliance of the air or gas in the rear cavity, of the air in the front cavity, of the suspension of the diaphragm and of the acoustic impedance of the port structure.

Typically, the first acoustic system will have one or more resonance frequencies. For example, the diaphragm and the rear cavity, i.e. the air or the gas within the rear cavity, may form a primary first system resonance frequency. The port structure and the rear cavity, i.e. the air or the gas within the rear cavity may form a secondary first system resonance frequency.

Thus, the presence of the port structure may change the system frequency response, and may add a secondary resonance frequency to the system frequency response

The port structure and the rear cavity may form a resonator, which resonates with the secondary first system resonance frequency. The port structure may act as a low pass filter, such as a second order low pass filter, such as a low pass filter allowing for up to a 12 dB/decade attenuation, between the rear cavity and the ambient. Below the secondary first system resonance frequency, the port structure may thus act acoustically as an open hole, thereby allowing proper low frequency audio reproduction, while above the secondary first system resonance frequency, the port structure will act as closed.

The port structure fluidly connecting the rear cavity and ambient space and the rear cavity may contribute to a secondary first system resonance frequency between 100 Hz and 1 kHz, such as between 100 Hz and 500 Hz.

Thus, the acoustic mass of the port structure and the acoustic compliance of the rear cavity may be tuned to a secondary first system resonance frequency of between 100 Hz and 1 kHz, such as between 100 Hz and 500 Hz, such as at about 300 Hz.

The rear cavity may thus behave as a closed rear cavity above the secondary first system resonance frequency, and as an open cavity below the secondary first system resonance frequency. Thus, the port structure may be configured to act as an acoustically open hole between the rear cavity and ambient space at low frequencies.

The port structure and the rear cavity may be configured to act as a second order low pass filter, while at the same time reducing ambient noise at transitional frequencies. It is an advantage of being able to provide a second order low pass filter as the passive attenuation for high frequencies, such as for frequencies above 500 Hz, such as above 1000 Hz, thereby may be improved.

The port wall of the port structure may comprise one or more acoustically permeable sections, and the one or more acoustically permeable sections may be distributed along a length of the port wall, the one or more acoustically permeable sections may be distributed at different distances from the housing wall.

For an earphone having a port structure, such as a tube-like port, having a solid port wall, artefacts may be seen about the secondary resonance frequency for the system, i.e. the resonance frequency implied by the port structure. It has been found that at about the resonance frequency, ambient noise may be amplified, while there at the same time is a significant dip in the sound pressure at the user's ear.

The port structure has a first open end fluidly coupled to the rear cavity and a second open end fluidly coupled to ambient space, and the port cavity is defined by the first open end, the second open end and the port wall. The port structure may thus couple the rear cavity to ambient space via the port cavity. The port wall may extend from the housing wall into the rear cavity and/or into the ambient space. The length of the port wall in a direction being non-parallel to the housing wall may be between 5 and 30 mm, such as between 10 and 20 mm, such as more than 5 mm, such as more than 10 mm.

The port wall has one or more acoustically permeable sections fluidly connecting the port cavity with the rear cavity and/or the ambient space. It has been found by the present inventors that by providing a leaky port structure, such as a port structure having a port wall with one or more acoustically permeable sections, artefacts in the first system frequency response at or around the secondary first system frequency response may be reduced.

In some embodiments, the port wall has a port wall area, and the one or more acoustically permeable sections may be distributed over an area of between 5% and 80% of the port wall area, such as between 5% and 60%, such as between 5% and 50%, such as between 10% and 60%, such as between 10% and 80%. In some embodiments, the one or more acoustically permeable sections may be distributed over an area of more than 5% of the port wall area, such as over an area of more than 10%, 25% or 30%, such as over an area of less than 90% of the port wall area, such as less than 80%, such as less than 50%, or any possible combination thereof.

In some embodiments, the acoustically permeable sections may be any acoustically permeable sections, and the acoustically permeable sections may comprise through holes, acoustically resistive openings, through holes covered with an acoustical lossy material, through holes covered with an acoustical mesh, etc.

In one or more embodiments, the acoustic impedance of the one or more acoustically permeable sections may be between 500 and 8000 L/m²s, such as between 1000 L/m²s and 8000 L/m²s , such as between 5000 L/m²s and 8000 L/m²s. The acoustic impedance may be above 500 L/m²s, such as above 1000, such as above 5000 L/m²s. The acoustic impedance may be below 8000 L/m²s, such as below 5000 L/m²s, such as below 1000 L/m²s.

In some embodiments, the one or more acoustically permeable sections may be distributed discretely along the length of the port wall. For example, at least one acoustically permeable section may be a longitudinal section having a length corresponding to at least 80% of a length of the port structure, or wherein at least one acoustically permeable section is a circumferential section extending along at least 80% of a perimeter of the port wall, and/or wherein a width of the longitudinal section and/or a width of the circumferential section corresponds to less than 25% of the length of the port wall.

The port structure may have a longitudinal extension in a longitudinal direction non-parallel with the housing wall which is larger than a transversal extension in a direction parallel to the housing wall. The first and/or second opening of the port structure may be said to form a base of the port structure from which bases the port wall may extend.

The port structure may comprise a tubular member provided in the housing wall between the rear cavity and ambient space, the tubular member having a first open end fluidly coupled to the rear cavity and a second open end fluidly coupled to ambient space. The tubular member may have a tubular member wall and the tubular member wall, the first open end and the second open end may define the port cavity, the tubular member wall having one or more acoustically permeable sections coupled to the rear cavity and/or to ambient space. Thus, the port wall may be a tubular member wall.

In some embodiments, the port structure may comprise a tubular member wall defining the port cavity, and the tubular member may be an open tubular member having a base and a height. The tubular member may have a same size along the height as a cylinder, or the tubular member may be tapered. The base may have any shape, such as a polygon, a circle, etc. The shape of the base may have a circumscribed circle or the base may be circular, and the height relative to a diameter of the circumscribed circle or of the circular base may be larger than one.

In some embodiments, for example in some embodiments in which the port structure is a tubular member having a base and a height, it is understood that the base in one end of the tubular member forms the first open end, while the base in the other end of the tubular member forms the second open end. The port wall or the tubular member wall may form the sides of the tubular member.

In some embodiments, the port structure having a first open end, a second open end and a port wall defining the port cavity, may have the first open end being parallel to the second open end. In some examples, the first and second open end may be parallel to the housing wall.

Typically, the port wall is defined as forming the sides of the port structure. In some embodiments, the port wall is defined as the part extending from the first and/or second open end being parallel to or forming a first angle with the housing wall and extending either into the cavity or away from the housing wall into ambient space. The first angle formed between the first and/or second opening and the housing wall may be 0 degrees, such as +/−10 degrees, such as +/−15 degrees, such as +/−20 degrees.

In some embodiments, the port cavity has a first cross section having a first cross sectional area. The first cross sectional area may be defined as the smallest effective area encountered by air flowing through the port structure between the rear cavity and the ambient space. The first cross section may correspond to a base of the port structure, and the first cross sectional area may correspond to the area of the base.

In some embodiments, the combined open area comprising the area of the first opening, the area of the second opening and the area of the one or more acoustically permeable openings is smaller than 210% of the first cross sectional area, such as smaller than 220%, such as smaller than 230%, such as smaller than 250%, etc. of the first cross sectional area.

The rear cavity may be larger than the front cavity, or vice versa, or the rear cavity may be smaller than the front cavity. In some embodiments, the one or more acoustically permeable sections may be dimensioned to dampen the secondary resonance of the port structure by at least 10 dB, such as by at least 6 dB.

In some embodiments, the earphone may further comprise a resistive opening between the rear cavity and ambient space. Such a resistive opening may be provided to improve low frequency reproducibility, although this may reduce the passive noise reduction at low frequencies.

The earphone may in some embodiments further comprise a noise cancelling circuit being configured to receive an earphone audio signal, to implement an active noise cancelling function and to provide a noise cancelling audio signal to the ear of a wearer. Thus, the earphone may provide a combination of active noise reduction and passive noise reduction.

Furthermore, in some embodiments, the earphone may comprise further elements, such as a second diaphragm, such as additional vents or openings in the rear cavity or in the front cavity. Still further, the front cavity, or the acoustic compliance of the first cavity, and the first diaphragm may form a second acoustic system having a second frequency response. Still further, additional electronic circuits or processors may be provided in the earphone for any additional or alternative purpose.

The earphone may have one or more input transducers, such as one or more microphones. The earphone may comprise an electronic noise cancelling circuit configured to receive ambient audio via at least a first of the one or more input transducers to implement an active noise cancelling function and to provide a noise cancelling audio signal to an output transducer, such as a speaker or such as the actively driven diaphragm.

The ear cushion may have any shape, texture and material properties suitable for providing an acoustic seal between the head and the earphone, however allowing passage of the acoustic output signal to the ear canal.

Suitable shapes include annular shapes, such as e.g. toroid shapes, nearly annular shapes, such as e.g. elliptic, oval or rounded-square shapes or distorted toroid shapes, bowl-like shapes, etc. The ear cushion, or at least a portion hereof, may be resilient and may e.g. comprise foam, rubber and/or silicone and other suitable materials known in the art. The earphone and the ear cushion may e.g. be adapted for circumaural or supraaural use and the ear cushion is a shaped or configured to provide a seal against a wearer's head or a wearer's ear, such as the pinna of the ear, or outer ear.

Alternatively or additionally, the earphone may be provided as an in the ear earphone, such as an earplug or an earbud earphone, and the ear cushion may be shaped and adapted to provide a seal against the concha and/or the ear canal wall.

Within this document, the term “earphone” refers to a device that is configured to be worn at, on or in one ear of an individual (the wearer) and is capable of providing an audible acoustic output signal to the wearer. An earphone may itself constitute a hearing device, or it may be comprised by a hearing device, such as e.g. a headset, a headphone, a hearing protector or a hearing aid. Hearing devices may e.g. be used for conveying audio signals in an audible format to a person, for augmenting a normal-hearing person's hearing capability, for protecting a person's hearing capability while allowing the person to hear sounds from the environment and/or for compensating for a hearing-impaired person's loss of hearing capability.

An earphone may preferably be retained in position at, on or in the ear by a wearing device, such as e.g. a headband, a neckband, an earhook or the like. The wearing device may be an integral part of the earphone and/or of the hearing device. For example, the housing of an earbud or earplug earphone may have a shape that fits into the concha and thus allows the housing itself to function as a wearing device. As another example, a hearing-device part comprising e.g. electronics may be adapted to be arranged behind the ear and be connected to an earbud or earplug earphone adapted to be arranged in the ear, and the behind-the-ear part may thus function as an earhook. An earphone is preferably configured to emit an acoustic signal such that it may enter the wearer's ear canal and thus may be heard by the wearer.

One or more of the acoustic output signals are preferably provided in the form of an air-borne acoustic signal that is emitted such that it may reach the wearer's ear. The earphone may comprise one or more vibration devices, each capable of providing a mechanical vibration signal and configured to acoustically couple the mechanical vibration signal as an audible acoustic output signal to the wearer's inner ear through the bone structure of the wearer's head.

An earphone may provide one or more of the acoustic output signals in dependence on one or more audio input signals, such as e.g. electronically received audio signals, acoustic signals received from the wearer's surroundings and/or audio signals stored or generated in the hearing device.

An earphone may comprise one or more receivers for electronically receiving one or more audio input signals. A receiver may comprise an electric connector, e.g. arranged in a housing part of the earphone or at the distal end of a cable extending from the earphone, to which another device may be electrically connected to provide one or more audio input signals. A receiver may be adapted to receive one or more audio input signals wirelessly using any known wireless transmission signals, such as e.g. radio frequency signals, optical signals or acoustic signals. A receiver may be adapted to receive wired or wireless signals as analog signals and/or as digital signals and may comprise demodulators and/or decoders for deriving one or more audio input signals from one or more modulated and/or encoded wired or wireless transmission signals.

An earphone may comprise one or more input transducers for receiving one or more acoustic input signals from the wearer's surroundings and providing corresponding audio input signals. An earphone may comprise one or more signal processing circuits adapted to apply any combination of known signal processing, such as e.g. amplification, attenuation, noise reduction, frequency filtering, spatial filtering, reduction of acoustic feedback, level compression etc., in an audio signal path or in multiple audio signal paths receiving the one or more audio input signals and providing the one or more acoustic output signals in dependence on the one or more audio input signals.

In general, an earphone comprises an output transducer for providing an audible acoustic output signal to a wearer in dependence on an audio output signal. An earphone may comprise one or more of the receivers of the hearing device, and/or one or more of the input transducers of the hearing device, and/or one or more of the signal processing circuits of the hearing device, and/or one or more of the own-voice microphones of the hearing device, and/or one or more of the transmitters of the hearing device. Thus, the functions of receiving, providing and/or processing the one or more audio input signals as well as the functions of receiving and/or transmitting voice audio signals may reside entirely in an earphone, or they may be distributed in any suitable fashion between an earphone and further parts of a hearing device comprising the earphone. An earphone may receive the audio output signal from another device. Alternatively, or additionally, an earphone may receive one or more, possibly pre-processed, audio input signals and process one or more of the audio input signals and/or pre-processed audio input signals to provide the audio output signal. In the following, any audio signal received by an earphone is referred to as an “earphone audio signal”.

An earphone audio signal may thus comprise e.g. an acoustic input signal, an audio input signal, a pre-processed audio input signal and/or an audio output signal. An earphone may e.g. provide one or more received earphone audio signals directly to the output transducer, or it may transduce and/or process one or more received earphone audio signals and provide the one or more transduced and/or processed earphone audio signals to the output transducer.

In general, a hearing device is configured to be worn at least partly at or on the wearer's head, typically comprises one or two earphones and is capable of providing one or more audible acoustic output signals to at least one of the wearer's ears. A hearing device may thus be monaural or binaural.

A hearing device may comprise one or more own-voice microphones arranged to receive the wearer's voice and adapted to provide one or more corresponding voice audio signals as well as one or more transmitters adapted to transmit one or more voice audio signals to another device connected to the hearing device, such as e.g. base station, a mobile phone, a computer or the like.

The term “hearing system” refers to a system comprising multiple devices of which at least one is a hearing device. A hearing system may comprise multiple hearing devices and/or one or more auxiliary devices. Auxiliary devices are devices that communicate with one or more of the hearing devices and affect and/or benefit from the function of the hearing devices. Auxiliary devices may be e.g. base stations, remote controls, audio gateway devices, mobile phones, public-address systems, car audio systems, personal computers and/or music players.

Within this document, the singular forms “a”, “an”, and “the” are intended to include the plural forms as well (i.e. to have the meaning “at least one”), unless expressly stated otherwise. Correspondingly, the terms “has”, “includes”, “comprises”, “having”, “including” and “comprising” specify the presence of respective features, operations, elements and/or components, but do not preclude the presence or addition of further entities. Furthermore, when an element is referred to as being “connected” or “coupled” to another element, this includes direct connection/coupling and connection/coupling via intervening elements, unless expressly stated otherwise. The term “and/or” includes any and all combinations of one or more of the associated items. The steps or operations of any method disclosed herein need not be performed in the exact order disclosed, unless expressly stated otherwise.

Ordinal attributes, such as “primary”, “secondary”, “main” and “auxiliary”, are intended to allow the reader to distinguish between different elements, and should not be construed as implying any element hierarchy or dependency, unless expressly stated otherwise.

Various embodiments are described hereinafter with reference to the figures. It should be noted that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

### BRIEF DESCRIPTION OF THE DRAWINGS

The invention will be explained in more detail below in connection with preferred embodiments and with reference to the drawings in which:

FIGS. 1A-1B schematically show an earphone according to the present disclosure,

FIGS. 2A-2D schematically show different acoustically permeable sections distributed along a port wall,

FIGS. 3A-3F schematically show a plurality of possible base shapes for a port structure according to the present disclosure,

FIG. 4 shows a port structure as disclosed herein,

FIGS. 5A-5B are curves showing the attenuation and the sound pressure at the ear of a wearer,

FIG. 6 shows the attenuation of a port structure with and without acoustically permeable sections,

FIG. 7 shows an earphone according to an embodiment of the disclosure further comprising a resistive port,

FIG. 8 shows an earphone according to an embodiment of the disclosure further comprising an active noise cancelling circuit.

### DETAILED DESCRIPTION OF THE DRAWING

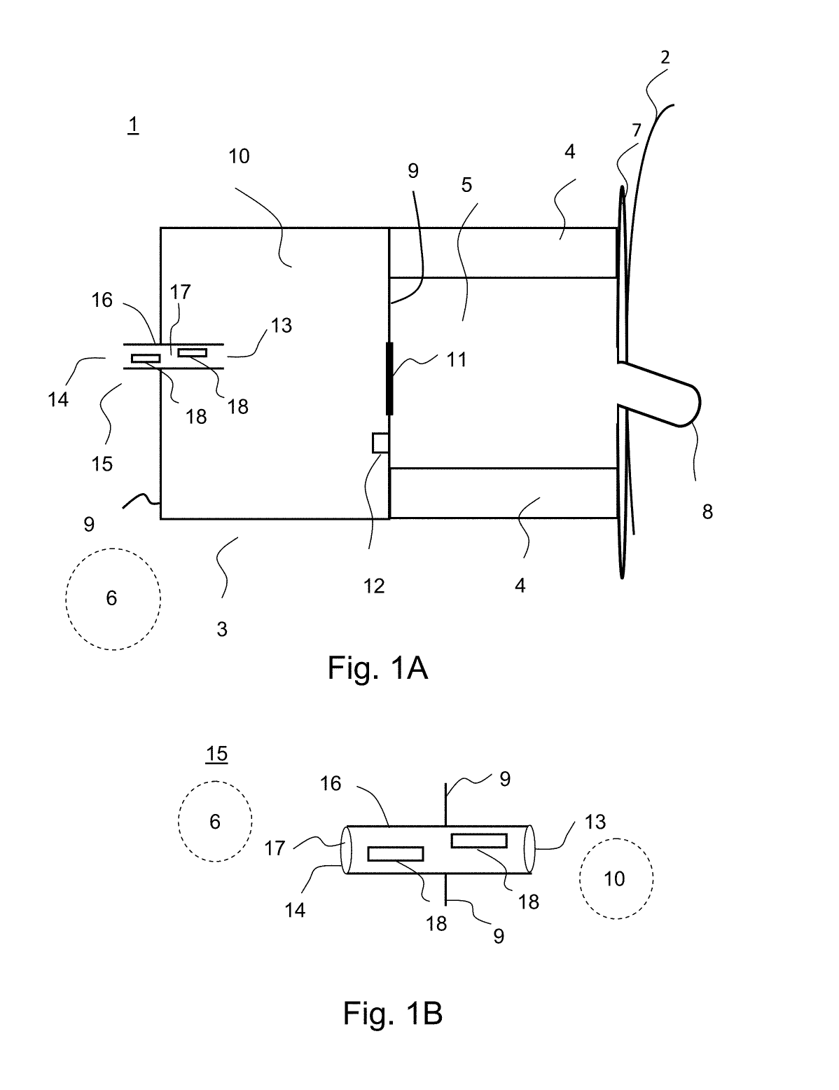

FIG. 1A shows an earphone 1 arranged in an operating position on the head 2 of a user or wearer of the earphone 1. The earphone 1 comprises a housing 3 with an annular ear cushion 4. The housing 3 and the ear cushion 4 together separate a front cavity 5 between the head 2 and the earphone 1 from ambient space 6 when the earphone 1 is in the operating position. The earphone 1 is adapted to provide an acoustic output signal to an ear 7 of the wearer in dependence on an earphone audio signal, and the operating position is preferably chosen such that the front cavity 5 comprises the ear canal 8 of the ear 7. The ear cushion 4 is arranged and adapted to attenuate acoustic signals entering the front cavity 5 from ambient space 6 when the earphone 1 is in the operating position. The attenuation provided by the ear cushion 4 at frequencies above 1 kHz may preferably be e.g. greater than 20 dB, greater than 10 dB or greater than 6 dB. The ear cushion 4 may be permanently or detachably attached to the housing 3 in any known way, e.g. by means of adhesives, screws, snap couplings and/or bayonet couplings.

The housing 3 has a wall 9 that separates a rear cavity 10 from the front cavity 5 and from ambient space 6. In some embodiments, the front cavity 5 may be substantially larger than the rear cavity 10, in other embodiments, the front cavity 5 and the rear cavity 10 may be comparable in size, and in further embodiments, the rear cavity 10 may be substantially larger than the front cavity 5. A first diaphragm 11 of a first electrodynamic driver 12 is reciprocatably suspended across an opening or a through hole in the housing wall 9 between the front cavity 5 and the rear cavity 10 and is adapted to be actively driven to provide at least a portion of the acoustic output signal. The first driver 12 thus functions as an output transducer of the earphone 1. Within this document, a “through hole” in a wall refers to a passage through the wall that fluidly connects the two opposite sides of the wall or in the case that a diaphragm is suspended across the through hole and thus obstructs the fluid passage, a passage that would fluidly connect the two opposite sides of the wall if the diaphragm were absent. In the earphone 1, the first diaphragm 11 obstructs the fluid passage through the through hole that would otherwise fluidly connect the front cavity 5 and the rear cavity 10.

The earphone 1 is configured to provide an acoustic output signal to an ear of a wearer in dependence on an earphone audio signal. The acoustic output signal is provided to the wearer via diaphragm 11 and front cavity 5. The earphone is furthermore configured to be arranged on the wearer's head 2 in an operating position such that a front cavity 5 between the head 2 and the earphone 1 is separated from ambient space 6. The earphone 1 comprises a housing 3 having a housing wall 9 separating a rear cavity 10 from the front cavity 5 and from ambient space 6. The earphone 1 further comprises an ear cushion 4 arranged and configured to attenuate acoustic signals entering the front cavity 5 from ambient space 6 when the earphone 1 is in the operating position. A first diaphragm 11 is suspended across an opening in the housing wall 9 between the front cavity 5 and the rear cavity 10 and configured to be actively driven to provide at least a portion of the acoustic output signal.

The first diaphragm 11 may be reciprocally suspended across the opening or the through-hole in the housing wall 9 between the front cavity 5 and the rear cavity 10, and thus be suspended to reciprocate. The first diaphragm 11 is configured to be actively driven to provide at least a portion of the acoustic output signal. The earphone 1 may comprise a first driver 12, such as a first electrodynamic driver, for driving the diaphragm 11.

The earphone 1 further comprises a port structure 15 fluidly connecting the rear cavity 10 and ambient space 6 through the housing wall 9. The port structure 15 has a first open end 13 fluidly coupled to the rear cavity 10 and a second open end 14 fluidly coupled to ambient space 6, and the port structure 15 has a port cavity defined by the first open end 13, the second open end 14 and a port wall 16, the port wall 16 extending from the housing wall 9 into the rear cavity 10 and/or into the ambient space 6. The port wall 16 has one or more acoustically permeable sections 18 fluidly connecting the port cavity 17 with the rear cavity 10 and/or the ambient space 6.

The first diaphragm 11, the rear cavity 10 (more precisely: the air or the gas within the rear cavity 10) and the port structure 15, i.e. the acoustic mass of the port structure, may together constitute or define a first acoustic system 10, 11, 15 having a first system frequency response. Typically, the first acoustic system has one or more resonance frequencies. For example, the diaphragm and the rear cavity, i.e. the air or the gas within the rear cavity, may form a primary first system resonance frequency. The port structure and the rear cavity, i.e. the air or the gas within the rear cavity may form a secondary first system resonance frequency.

The primary first system resonance frequency is controlled mainly by the acoustic mass of the first diaphragm 11 and the combined acoustic compliance of the air or gas in the rear cavity 10, of the air in the front cavity 5 and of the suspension of the first diaphragm 11. The secondary system resonance frequency is mainly controlled by the acoustic compliance of the air or gas in the rear cavity 10, and of the acoustic mass of the port structure 15.

In FIG. 1B, the port structure 15 is shown in more detail. The port structure 15 fluidly connects the rear cavity 10 and ambient space 6 through the housing wall 9. The port structure 15 has a first open end 13 fluidly coupled to the rear cavity 10 and a second open end 14 fluidly coupled to ambient space 6. The port structure 15 thus has a port cavity 17 defined by the first open end 13, the second open end 14 and a port wall 16. The port wall extends from the housing wall 9 into the rear cavity 10 and/or into the ambient space 6. The port wall 16 has one or more acoustically permeable sections 18 fluidly connecting the port cavity 17 with the rear cavity and/or the ambient space through the port wall 16.

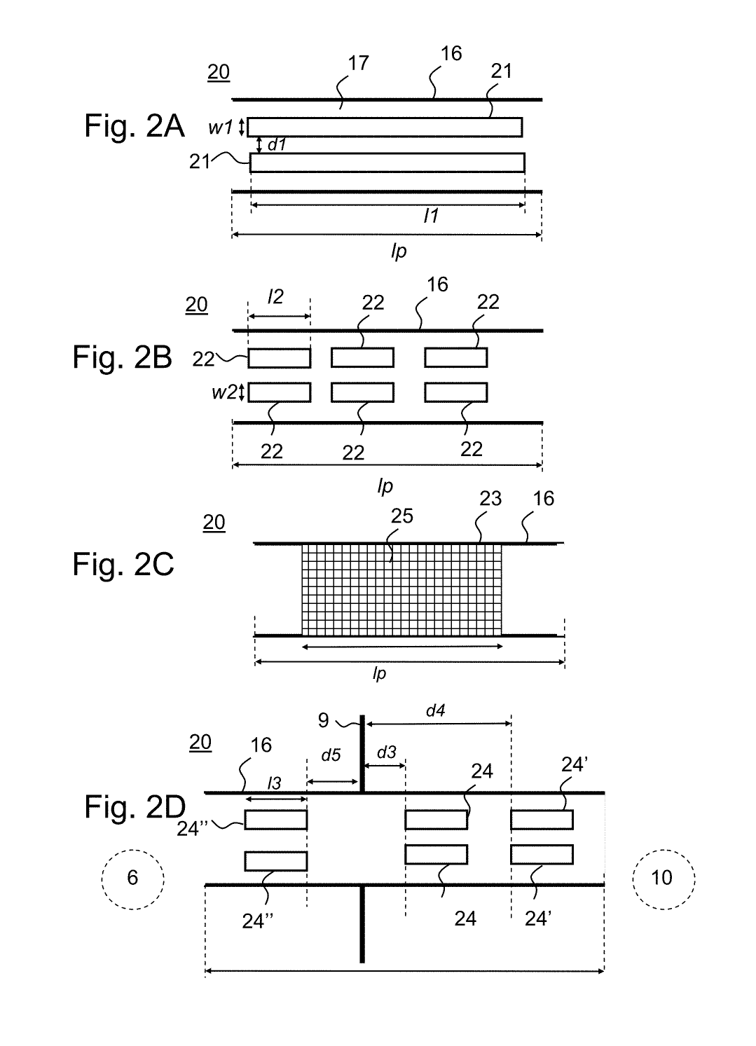

FIGS. 2A-2D show schematically different acoustically permeable sections distributed along a port structure 20. The schematised illustrations can be a view of the port structure 20 from any viewing angle, such as a side view, a top view, etc.

In FIG. 2A the acoustically permeable sections 21 are shown as longitudinal slits 21 in the port wall 16, the length l1 of the longitudinal slits 21 is comparable to an overall length of the port wall, lp. In some examples the longitudinal slits 21 may have a length l1 corresponding to at least 90% of the overall length lp of the port wall 16, such as corresponding to at least 80%, such as corresponding to at least 75%, such as corresponding to at least 66%, such as corresponding to at least 50% of the overall length lp of the port wall 16.

The slits 21 may have a width w1 being much smaller than the length l1, and the width may be less than 50% of a perimeter of the port structure 15, such as less than 33%, such as less than 15% of a perimeter of the port wall 16.

The distance dl between neighbouring slits may be comparable to the width w1 of the slits 21, and thus the distance d1 may be within +/−10%, such as within +/−20% of the width w1, such as within +/−50% of the width.

In FIG. 2B, the acoustically permeable sections 22 are shown as slits 22. Slits 22 are shown in a port wall 16 of a port structure 20. The slits 22 having a length l2 being smaller than the overall length 1p of the port wall 16. The length l2 may be less than 50%, such as 50%, such as less than 33%, such as less than 25%, such as less than 10% of the overall length lp of the length of the port wall 16. The width w2 and the distance d2 between neighbouring slits may be comparable to the width w1 and the distance d1 as discussed in connection with FIG. 2A. The slits 22 may be distributed along the port wall 16 in any regular or irregular way.

It is furthermore envisaged that also a combination of slits 21 and slits 22 may be provided on the port wall 16, so that different slits 21, 22 provided on a same port wall 16 may have different widths and different lengths.

It is furthermore envisaged that even though the slits 21, 22 are shown schematically as being rectangular, it is envisaged that the acoustically permeable sections may have any form, and be circular, elliptical, rectangular, be regular or irregular.

In FIG. 2C, an acoustically permeable section is provided as a through hole 23 of the port wall 16 covered with an acoustical mesh 25. The acoustical mesh 25 may have an acoustical mass or an acoustical impedance designed to provide a desired secondary resonance frequency.

The port wall 16 may have more than one through hole 23, and different through holes 23 may be covered with different acoustical mesh, or some through holes may be covered with acoustical mesh while others may remain through holes in the port wall 16.

In FIG. 2D, the housing wall 9 of the earphone housing 3 is shown, and it is seen that the port structure extends on both sides of the housing wall 9, and thus extends into the rear cavity 10, and into the ambient space 6. It is seen that the one or more acoustically permeable sections 24, 24′, 24″ may be distributed along a length of the port wall 16, the one or more acoustically permeable sections 24, 24′, 24″ may be distributed at different distances d3, d4, d5 from the housing wall.

It is envisaged that any of the acoustically permeable sections as discussed in connection with FIGS. 2A-2D may be used in any combination to obtain an acoustic impedance of the one or more acoustically permeable sections so as to be able to dampen the secondary first system resonance frequency. The one or more acoustically permeable sections may have a combined acoustic impedance of between 500 and 8000 L/m²s in order to dampen the secondary first system resonance frequency.

The port structure may have a port wall having any shape and being configured to define a port cavity, such as being configured to at least partly. enclose a cavity.

The port structure may be a longitudinal port structure, such as a port structure having a longitudinal extension being larger than a diameter, or a cross-section of a width, of the port structure, such as a port structure having a longitudinal extension in a longitudinal direction non-parallel with the housing wall which is larger than a transversal extension in a direction parallel to the housing wall.

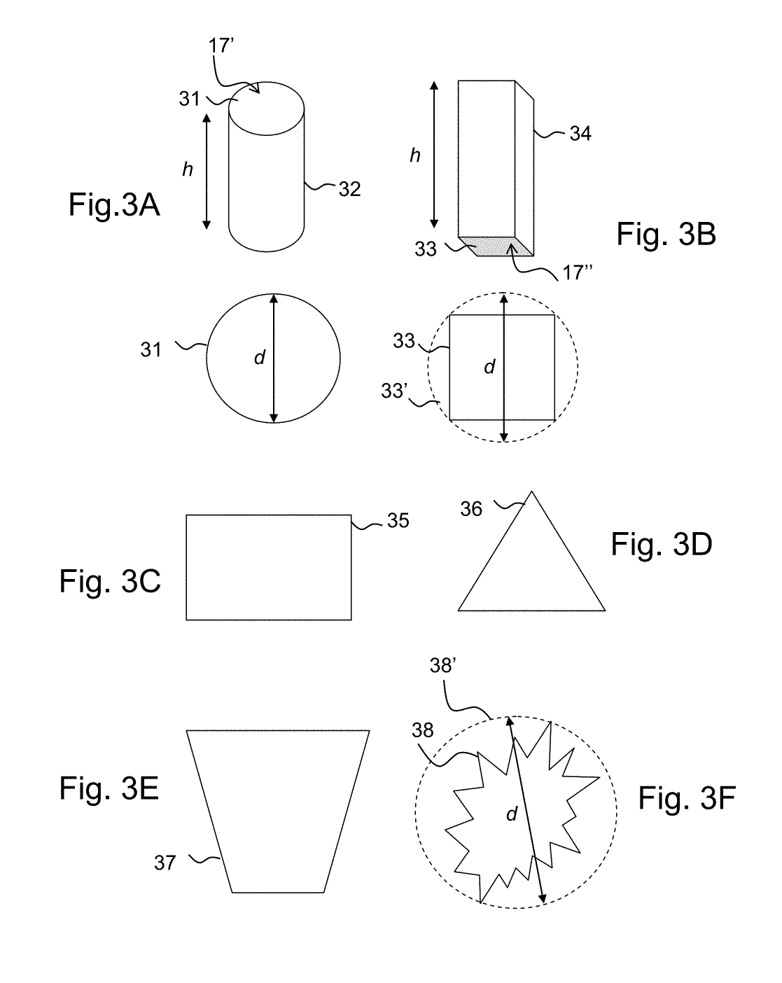

In FIGS. 3A-3F different shapes of port structures are shown. The port structure 15 may for example have a base 31, 33, 35, 36, 37, 38, and a wall part 32, 34 extending from the base 31, 33, 35, 36, 37, 38. The wall part 32, 34 may have a center corresponding to a center of the base along the entire length of the wall part, or the wall part may be for example tapered or conical.

The port structure may have open ends, so that the base 31, 33, 35, 36, 37, 38 of the port structure is open, while the port wall 32, 34 defines a cavity 17′, 17″ within the port wall 32, 34 having two open ends.

The base 31, 33, 35, 36, 37, 38 may have any shape, such as a polygon shape, a circular shape 31, a square shape 33, a rectangular shape 35, a triangular shape 36, a parallellogramic shape 37, or any irregular shape 38, etc. The shape of the base may have a circumscribed circle, 33′, 38′, or the base may be circular, and the height relative to a diameter of the circumscribed circle or of the circular base may be larger than one. For example in FIG. 3F, a base 38 having an irregular shape is shown. It is seen that the irregular shape of the base 38 has a circumscribed circle 38′, and the circumscribed circle has a diameter d.

The base 31, 33, 35, 36, 37, 38 may have a diameter or a cross-section, or a circumscribed circle of the base may have a circumscribed circle diameter. In some examples, the diameter of the base, the cross-sectional width of the base or the circumscribed circle diameter may be between 0.5 mm and 3 mm, such as between 0.8 mm and 2 mm, such as between 1.0 and 1.5 mm, such as about 1.2 mm

The port structure 15 may comprise a tubular member 32, 34 defining the port cavity 17, and the tubular member may be an open tubular member having a base 31, 33, 35, 36, 37, 38 and a height 39, 39′. Typically, the base may be an open end of the tubular member. The tubular member may have a same size along the height as a cylinder, or the tubular member may tapered. The base may have any shape as set out above.

Regardless of the shape of the port structure, and regardless of the shape of the base, the height relative to a diameter of a circumscribed circle of the base is preferably larger than one.

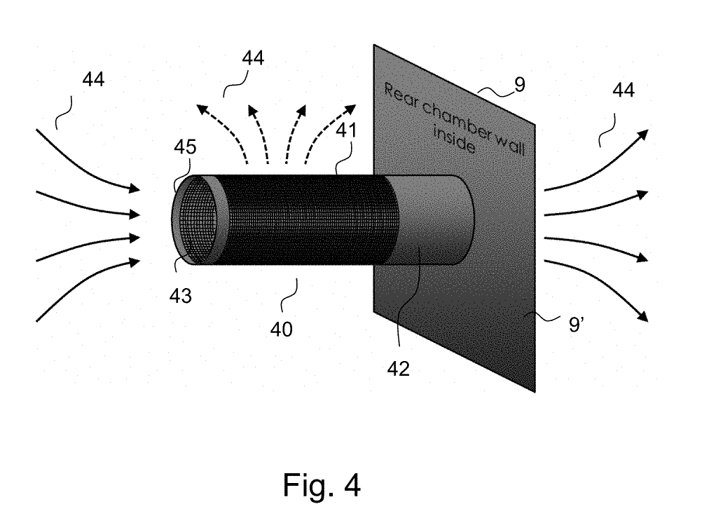

FIG. 4 shows an exemplary port structure 40 extending inside the cavity 10, away from the inside 9′ of the housing wall 9. The port structure 40 has a port wall 42 defining a port cavity 43. An acoustically permeable section 41 extends around a perimeter of the port wall 42. It is seen that at least some sound 44 entering the port structure 40 through opening 45 may escape the port cavity 43 through the acoustically permeable section 41. Also sound 44 may be guided through the port structure and escape through the opening (not shown) of the cavity opposite the opening 45.

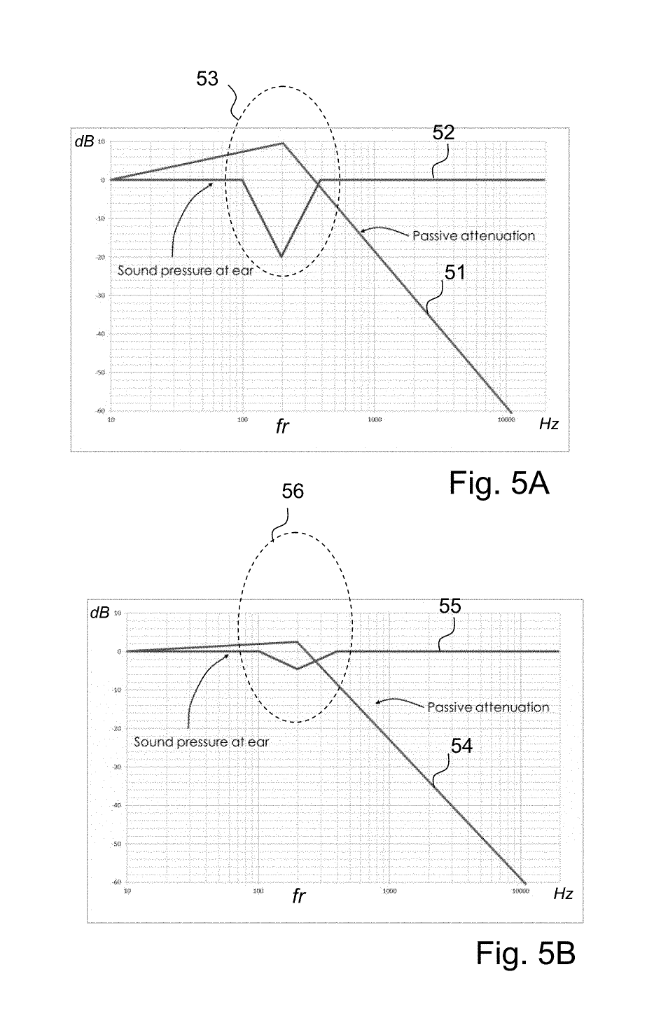

FIG. 5A shows the frequency response for a prior art earphone having a diaphragm, a rear cavity and a port structure having a solid port wall, i.e. an earphone according to FIG. 1, however, having a solid port wall 16. The prior art earphone may have a secondary system resonance frequency determined primarily by the rear cavity and the port structure, see area 53. The frequency response may exhibit further resonance frequencies, these are however omitted from the frequency response for simplification. In FIG. 5A, the curve 51 shows the frequency dependent passive attenuation of the noise, while the curve 52 shows the sound pressure at the ear.

In FIG. 5A, it is seen that about the secondary resonance frequency fr for the prior art earphone, see the area 53 of the chart, the noise is amplified, while there is a significant drop in pressure at the ear.

In FIG. 5B, a first system frequency response for an earphone corresponding to an earphone according to the present disclosure is shown. It should be noted that the first system frequency response may exhibit further resonance frequencies, these are however omitted from the illustrated frequency response in FIG. 5B for simplification. In FIG. 5B, the curve 54 shows the frequency dependent passive attenuation of the noise, while the curve 55 shows the sound pressure at the ear.

It may be seen from FIG. 5B that at about the resonance frequency, see the area 56, i.e. about the secondary first system resonance frequency, fr, the amplification of the noise, ambient sound, etc., is reduced and the amplification is seen to be about 1-2 dB, and thus the amplification of the noise is less than 5 dB, such as less than 2 dB, such as less than 1 dB. Thus, the reduction of the amplification is more than 50%, such as more than 80% compared to a structure having a solid port wall. It is furthermore seen from FIG. 5B that also the reduction of a sound pressure at the ear of the user is significantly reduced, and the sound pressure may only drop to e.g. 5 dB, such as less than 5 dB, such as less than 10 dB, whereas in an earphone having a solid port wall, the pressure at the ear may drop by 20 dB as seen from FIG. 5B.

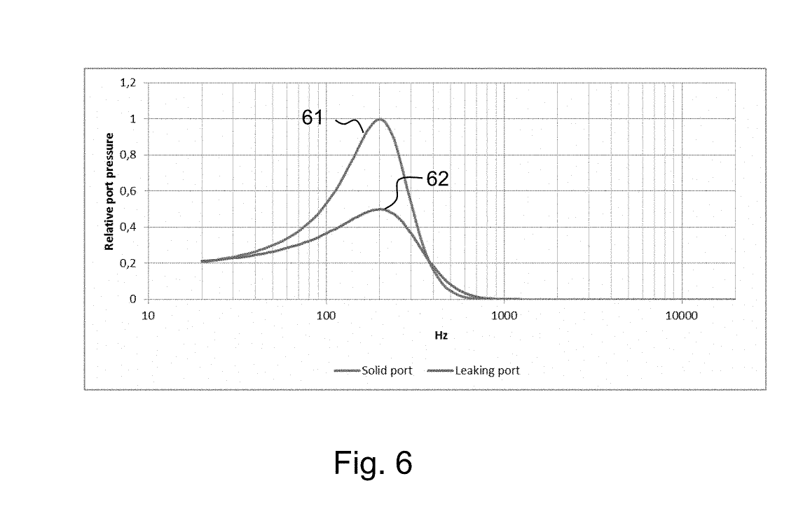

In FIG. 6, a comparison is made between the relative port pressure as a function of frequency. From FIG. 6, it is seen that if the relative port pressure at the resonance frequency for a solid port wall is equalled 1, see frequency response curve 61, then the relative sound pressure at a leaky port wall, i.e. a port wall having one or more acoustically permeable openings, see frequency response curve 62, the port pressure is significantly reduced, and at the resonance frequency, the relative port pressure may be reduced by at least 50%, such as by at least 45%.

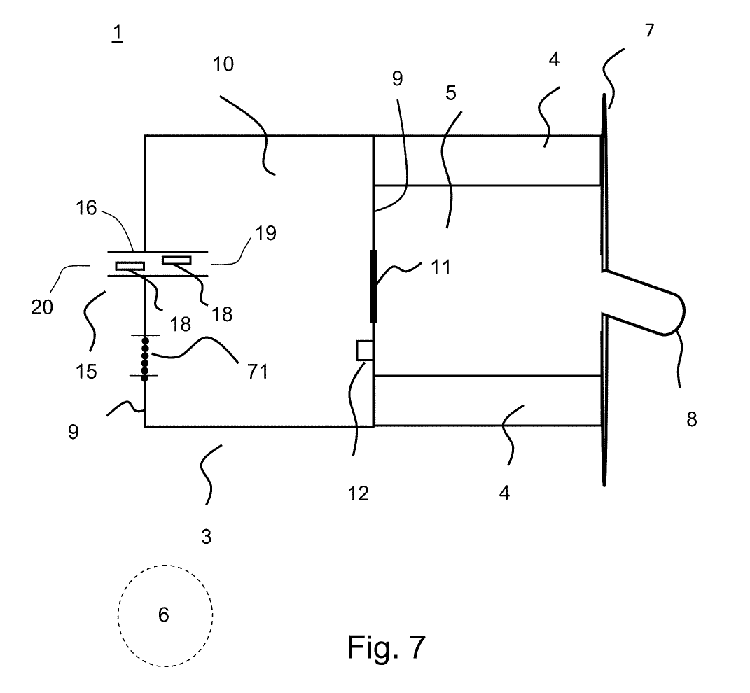

FIG. 7 shows an earphone according to the present disclosure, and the earphone 70 is configured to provide an acoustic output signal to an ear of a wearer in dependence on an earphone audio signal and further configured to be arranged on the wearer's head 2 in an operating position such that a front cavity 5 between the head 2 and the earphone 70 is separated from ambient space 6. The earphone 70 comprises a housing 3 having a housing wall 9 separating a rear cavity 10 from the front cavity 5 and from ambient space 6. The earphone 70 further comprises an ear cushion 4 arranged and configured to attenuate acoustic signals entering the front cavity 5 from ambient space 6 when the earphone 70 is in the operating position. A first diaphragm 11 is suspended across an opening in the housing wall 9 between the front cavity 5 and the rear cavity 10 and configured to be actively driven to provide at least a portion of the acoustic output signal.

The first diaphragm 11 may be reciprocally suspended across the opening or the through-hole in the housing wall 9 between the front cavity 5 and the rear cavity 10, and thus be suspended to reciprocate. The first diaphragm 11 is configured to be actively driven to provide at least a portion of the acoustic output signal. The earphone 70 may comprise a first driver 12, such as a first electrodynamic driver, for driving the diaphragm 11.

The earphone 70 further comprises a port structure 15 fluidly connecting the rear cavity 10 and ambient space 6 through the housing wall 9. The port structure 15 has a port wall 16 defining a port cavity 17 and the port wall 16 extends from the housing wall 9 into the rear cavity 10 and/or into the ambient space 6. The port wall 16 has one or more acoustically permeable sections 18 fluidly connecting the port cavity 17 with the rear cavity 10 and/or the ambient space 6.

The earphone 70 furthermore comprises a resistive opening 71, the resistive opening 71 acting as a vent. Such a vent typically acts as a first order filter, and may provide an attenuation of about 6 dB/decade.

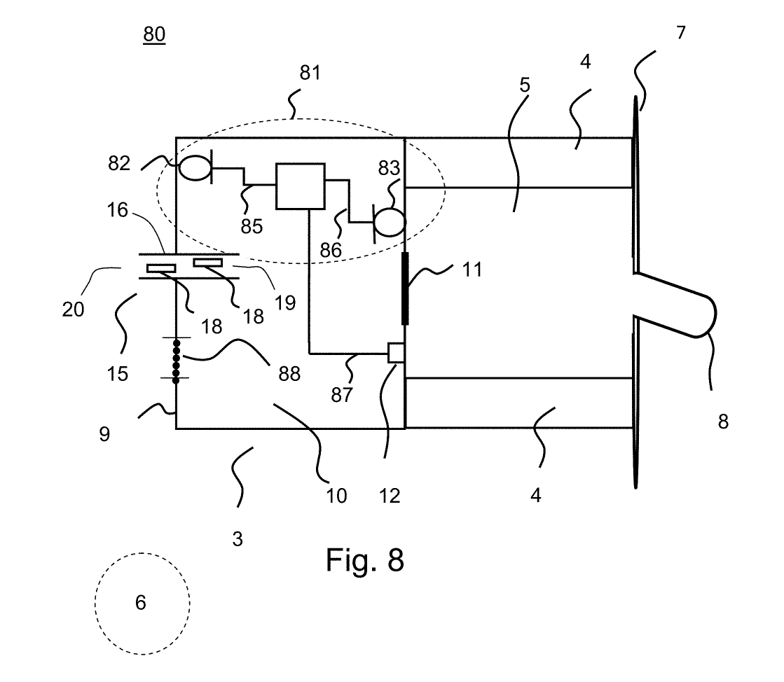

FIG. 8 shows another earphone according to the present disclosure, and the earphone 80 is configured to provide an acoustic output signal to an ear of a wearer in dependence on an earphone audio signal and further configured to be arranged on the wearer's head 2 in an operating position such that a front cavity 5 between the head 2 and the earphone 80 is separated from ambient space 6. The earphone 80 comprises a housing 3 having a housing wall 9 separating a rear cavity 10 from the front cavity 5 and from ambient space 6. The earphone 80 further comprises an ear cushion 4 arranged and configured to attenuate acoustic signals entering the front cavity 5 from ambient space 6 when the earphone 80 is in the operating position. A first diaphragm 11 is suspended across an opening in the housing wall 9 between the front cavity 5 and the rear cavity 10 and configured to be actively driven to provide at least a portion of the acoustic output signal.

The first diaphragm 11 may be reciprocally suspended across the opening or the through-hole in the housing wall 9 between the front cavity 5 and the rear cavity 10, and thus be suspended to reciprocate. The first diaphragm 11 is configured to be actively driven to provide at least a portion of the acoustic output signal. The earphone 80 may comprise a first driver 12, such as a first electrodynamic driver, for driving the diaphragm 11.

The earphone 80 further comprises a port structure 15 fluidly connecting the rear cavity 10 and ambient space 6 through the housing wall 9. The port structure 15 has a port wall 16 defining a port cavity 17 and the port wall 16 extends from the housing wall 9 into the rear cavity 10 and/or into the ambient space 6. The port wall 16 has one or more acoustically permeable sections 18 fluidly connecting the port cavity 17 with the rear cavity 10 and/or the ambient space 6.

The earphone 80 furthermore comprises an active noise cancelling circuit 81, the active noise cancelling circuit being configured to actively counteract incoming noise. The earphone 80 thus further comprises a feedforward microphone 82 and/or a feed backward microphone 83, and the active noise cancelling circuit 81 receives microphone signals 85, 86 from the feedforward and/or feed backward microphones 82, 83 and generates an active noise cancelling output signal 87 which is fed to the driver 12 of the diaphragm 11 to provide a noise cancelling signal to the user or wearer of the earphone.

Any of the earphones 1, 70, 80 described above may further comprise any suitable combination of the features described above as generally possible features of an earphone. Any of the earphones 1, 70, 80 may be comprised in a hearing device (not shown), such as e.g. a headset, a headphone, a hearing protector or a hearing aid. The hearing device may further comprise any suitable combination of the features described above as generally possible features of a hearing device and may further comprise any suitable combination of further features that are part of known hearing devices. Where suitable, such features may be comprised by the earphone 1, 70, 80.

Although particular embodiments have been shown and described, it will be understood that it is not intended to limit the claimed inventions to the preferred embodiments, and it will be obvious to those skilled in the art that various changes and modifications may be made without departing from the spirit and scope of the claimed inventions. The specification and drawings are, accordingly, to be regarded in an illustrative rather than restrictive sense. The claimed inventions are intended to cover alternatives, modifications, and equivalents.

### LIST OF REFERENCES

1 earphone

2 head of a user

3 housing

4 ear cushion

5 front cavity

6 ambient space

7 ear

8 ear canal

9 housing wall

10 rear cavity

11 diaphragm

12 driver

13 first open end

14 second open end

15 port structure

16 port wall

17, 17′, 17″ port cavity

18 acoustically permeable section

21,22 slit

23 through hole

24, 24′, 24″ acoustically permeable section

25 acoustical mesh

31, 33, 35, 36, 37, 38 base

32, 34 wall part

39, 39′ height

40 port structure

41 acoustically permeable section

42 port wall

43 port cavity

44 sound

45 opening

51 curve showing frequency dependent passive attenuation

52 curve showing the sound pressure at the ear

53 area of chart

54 curve showing frequency dependent passive attenuation

55 curve showing the sound pressure at the ear

56 area of chart

70 earphone

80 earphone

81 active noise cancelling circuit

82 feedforward microphone

83 feed backward microphone

85, 86 microphone signals

87 active noise cancelling output signal

1. An earphone configured to provide an acoustic output signal to an ear of a wearer in dependence on an earphone audio signal and further configured to be arranged on the wearer's head in an operating position such that a front cavity between the head and the earphone is separated from ambient space, the earphone comprising:
a housing having a housing wall separating a rear cavity from the front cavity and from ambient space;
an ear cushion arranged and configured to attenuate acoustic signals entering the front cavity from ambient space when the earphone is in the operating position;
a first diaphragm suspended across an opening in the housing wall between the front cavity and the rear cavity and configured to be actively driven to provide at least a portion of the acoustic output signal;
a port structure fluidly connecting the rear cavity and ambient space through the housing wall, the port structure having a first open end fluidly coupled to the rear cavity and a second open end fluidly coupled to ambient space, and the port structure having a port cavity defined by the first open end, the second open end and a port wall, the port wall extending from the housing wall into the rear cavity and/or into the ambient space, wherein the port wall has one or more acoustically permeable sections fluidly connecting the port cavity with the rear cavity and/or the ambient space through the port wall.

2. An earphone according to claim 1, wherein the port structure fluidly connecting the rear cavity and ambient space has a port structure resonance frequency, and wherein the port structure resonance frequency is between 100 Hz and 1 kHz, such as between 100 Hz and 500 Hz.

3. An earphone according to claim 1, wherein the port structure and the rear cavity are configured to act as a second order low pass filter.

4. An earphone according to claim 1, wherein the port structure is configured to act as an acoustically open hole between the rear cavity and ambient space at low frequencies.

5. An earphone according to claim 1, wherein the one or more acoustically permeable sections are distributed along a length of the port wall, or wherein the one or more acoustically permeable sections are distributed at different distances from the housing wall.

6. An earphone according to claim 1, wherein the port wall has a port wall area, and wherein the one or more acoustically permeable sections are distributed over between 5% and 50% of the port wall area.

7. An earphone according to claim 1, wherein the one or more acoustically permeable sections comprises through holes, acoustically resistive openings, through holes covered with an acoustical lossy material, through holes covered with an acoustical mesh.

8. An earphone according to claim 1, wherein the acoustic impedance of the one or more acoustically permeable sections is between 500 and 8000 L/m²s.

9. An earphone according to claim 1, wherein the one or more acoustically permeable sections are distributed discretely along the length of the port wall

10. An earphone according to claim 1 any of the procoding claims, wherein the port structure has a longitudinal extension in a longitudinal direction non-parallel with the housing wall which is larger than a transversal extension in a direction parallel to the housing wall.

11. An earphone according to claim 1, wherein the port structure comprises a tubular member having a first open end fluidly coupled to the rear cavity and a second open end fluidly coupled to ambient space, the tubular member having a tubular member wall defining the port cavity, and wherein the tubular member has a base and a height, the base having a circumscribed circle or the base being circular, wherein the height relative to a diameter of the circumscribed circle or of the circular base is larger than one.

12. An earphone according to claim 1, wherein the one or more acoustically permeable sections are dimensioned to dampen the resonance of the port structure by at least 6 dB.

13. An earphone according to claim 1, wherein at least one acoustically permeable section is a longitudinal section having a length corresponding to at least 80% of a length of the port wall, or wherein at least one acoustically permeable section is a circumferential section extending along at least 80% of a circumference of the port wall, and/or wherein a width of the longitudinal section and/or a width of the circumferential section corresponds to less than 25% of the length of the port wall.

14. An earphone according to claim 1, the earphone further comprising a noise cancelling circuit being configured to receive the earphone audio signal, to implement an active noise cancelling function and to provide a noise cancelling audio signal to the ear of a wearer.

15. A hearing device comprising one or two earphones according to claim 1 and configured to provide an earphone audio signal to each of the one or two earphones in dependence on one or more audio input signals.
